(19) United States
(12) Patent Application Publication
(10) Pub. No.: US 2010/0037239 A1
(43) Pub. Date: Feb. 11, 2010

(54) PORTABLE TERMINAL AND METHOD OF CONTROLLING EXTERNAL INTERFACE THEREOF

(75) Inventors: Minho Han, Daejeon (KR); Boheung Chung, Daejeon (KR); Kiyoung Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejon (KR)

(21) Appl. No.: 12/475,079

(22) Filed: May 29, 2009

(30) Foreign Application Priority Data
Aug. 5, 2008 (KR) 10-2008-0076390

(51) Int. Cl. G06F 9/44

(52) U.S. Cl. 719/321

(57) ABSTRACT

The present invention relates to a portable terminal and a method of controlling an external interface thereof. When a system call that requests to open a external interface is input from a user process in a portable terminal that is connected to a plurality of external interfaces, a driver of the external interface is opened or intercepted using an external interface policy where open or intercepted information for each of the plurality of external interfaces is recorded to correspond to the user process. According to the present invention, an external interface that is not used by the portable terminal can be prevented from operating if externally attacked regardless of the user's intention.

### RELATED APPLICATIONS

The present application claims priority to Korean Patent Application Serial Number 10-2008-0076390, filed on Aug. 5, 2008, the entirety of which is hereby incorporated by reference.

### BACKGROUND OF THE INVENTION

1. Field of the Invention

The present invention relates to a portable terminal and a method of controlling an external interface thereof, and more particularly, to a portable terminal that has a security reinforcement function for an external interface of the portable terminal and a method of controlling an external interface thereof.

2. Description of the Related Art

In general, devices can be considered as peripheral devices other than a computer system, such as a hard disk, a floppy disk, and a printer. A device driver is a program that is a portion of a kernel that enables data to be exchanged between the devices and the computer system and is used to control the devices.

An operating system (OS) is provided with a general-purpose interface for various device drivers. At this time, when the device driver detects a new device, the device driver installs a driver that supports the new device using the general-purpose interface. The operating system provides an application program that can control the devices through a system call, thereby enabling the corresponding devices to be used.

The portable terminal also needs to implement a device driver in order to use various external interfaces, such as WLAN, CDMA, DMB, and Bluetooth. That is, a processor attempts to call a system to use the external interfaces. At this time, the device driver opens an external interface driver that corresponds to the system call from the processor. As a result, the processor is connected to the external interface and transmits data to or receives data from the external interface.

However, in the case of the portable terminal, an external interface that is not generally used by the portable terminal still operates if externally attacked regardless of the user's intention, which may result in leaking important information or levying the utilization rate unfairly.

### SUMMARY OF THE INVENTION

Accordingly, the present invention has been made to solve the above-described problems, and it is an object of the present invention to provide a portable terminal and a method of controlling an external interface thereof that can minutely control external interfaces used by the portable terminal and reinforce security for the portable terminal.

According to an embodiment of the present invention, there is provided a portable terminal that is connected to a plurality of external interfaces. The portable terminal includes an external interface control module that confirms whether or not to open an open-requested external interface on the basis of an external interface policy where open or intercepted information for each of the plurality of external interfaces is recorded to correspond to a user process, when a system call command that requests to open the external interface is input from the user process; and a device driver that opens or intercepts the open-requested external interface in accordance with a control command from the external interface control module.

According to another embodiment of the present invention, there is provided a method of controlling an external interface of a portable terminal that is connected to a plurality of external interfaces. The method includes receiving a system call command that requests to open an external interface from a user process; confirming whether or not to open the open-requested external interface on the basis of an external interface policy where open or intercepted information for each of the plurality of external interfaces is recorded to correspond to the user process; and opening or intercepting the open-requested external interface according to the confirmed result.

According to still another embodiment of the present invention, there is provided a processor readable recording medium that records a program to execute the above-described external interface control method.

According to the present invention, an external interface policy for a plurality of external interfaces, which are connected to a portable terminal, is set for each of user processes. Therefore, an external interface that is not used by the portable terminal can be prevented from operating if externally attacked regardless of the user's intention. As a result, it is possible to reinforce security for the portable terminal.

### BRIEF DESCRIPTION OF THE DRAWINGS

FIG. 1 is a diagram illustrating the structure of a portable terminal according to an embodiment of the present invention;

FIG. 2 is an exemplary view illustrating the operation of a portable terminal according to an embodiment of the present invention; and

FIG. 3 is a flowchart illustrating an operational flow of a method of controlling an external interface of a portable terminal according to an embodiment of the present invention.

### DESCRIPTION OF THE PREFERRED EMBODIMENTS

Hereinafter, the preferred embodiments of the present invention will be described with reference to the accompanying drawings.

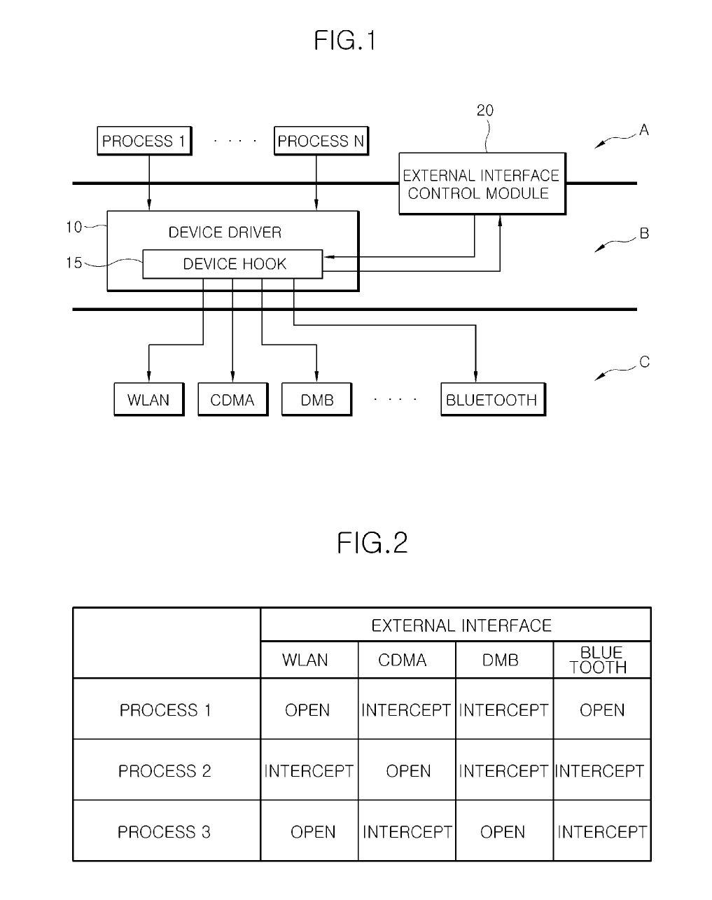

FIG. 1 shows the partial structure of a portable terminal that is needed to implement an external interface control method according to an embodiment of the present invention. Referring to FIG. 1, an area of a portable terminal according to an embodiment of the present invention is generally divided into a user area A, a kernel area B, and a hardware area C.

In this case, the user area A that can be controlled by a user indicates an area where a corresponding user process is called in accordance with a request from the user. Meanwhile, the kernel area B indicates an area where the called user process is implemented and an operating system (OS) is implemented. Meanwhile, the hardware area C is an area where hardware devices of the portable terminal and peripheral devices thereof, that is, devices are implemented.

Further, in the hardware area, a plurality of external interfaces, which include wireless-LAN (WLAN), code division multiple access (CDMA), digital multimedia broadcasting (DMB), and Bluetooth, may be implemented.

The portable terminal according to the embodiment of the present invention includes a device driver 10 and an external interface control module 20, which function as components that are needed to implement an external interface control method. In this case, the device driver 10 is implemented in the kernel area B and operated by an operating system. Meanwhile, the external interface control module 20 is implemented in the user area A and the user area B and operated by the user and the operating system.

The portable terminal further includes a device hook 15 that is implemented in the device driver 10 and transmits a system call command, which is input from a user process, to the external interface control module 20. In this embodiment, the device hook 15 is implemented in the device driver 10, but the present invention is not limited thereto. The device hook 15 may be implemented between the user processor and the device driver 10.

The device driver 10 supports an external interface driver for a plurality of external interfaces, which are connected to the portable terminal. If a system call command is input from the user processor, the device driver 10 opens a corresponding external interface driver, thereby enabling the user processor to be implemented through the corresponding external interface.

If the system call command is input to the device driver 10, the device hook 15 hooks the system call command such that the system call command is input to the external interface control module 20. In this case, it is assumed that the device hook 15 hooks a system call command that requests to open an external interface.

The external interface control module 20 sets an external interface policy that confirms whether to open or intercept each of the external interfaces connected to the portable terminal, for each of the user processes of the portable terminal. In this case, the external interface control module 20 can change an external interface policy that is set for each of the user processes in accordance with the request from the user.

If receiving a system call command that is hooked by the device hook 15, the external interface control module 20 detects user process information and information of an open-requested external interface. The external interface control module 20 calls an external interface policy that corresponds to a user process and compares the external interface policy with the detected information of the external interface, thereby confirming whether or not to allow the open-requested external interface to be open. At this time, the external interface control module 20 provides the confirmed result to the device driver 10.

For example, in the case where an external interface policy of a process that is related to data transmission is set to open only external interfaces, such as WLAN and Bluetooth, if it is required to open external interfaces, such as CDMA and DMB, except for WLAN and Bluetooth, while the process related to data transmission is executed, the external interface control module 20 confirms, from the external interface policy that corresponds to the process related to data transmission, that the external interfaces, such as CDMA and DMB, are intercepted, and provides the confirmed result to the device driver 10.

Meanwhile, the device driver 10 opens or intercepts a driver of the open-requested external interface in accordance with a control command from the external interface control module 20. That is, as the confirmed result of the control command that is input from the external interface control module 20, when it is allowed to open the corresponding external interface, the device driver 10 opens the driver of the open-requested external interface. When it is not allowed to open the corresponding external interface, the device driver 10 intercepts the driver of the open-requested external interface.

Accordingly, since it is possible to open only a driver of an external interface that is allowed to be open in accordance with an external interface policy set for each of the user processes, an external interface can be prevented from operating if externally attacked regardless of the user's intention.

FIG. 2 shows the operation of a portable terminal according to an embodiment of the present invention. Specifically, FIG. 2 shows an embodiment of an external interface policy that is set for each of the user processes. In the embodiment shown in FIG. 2, it is assumed that external interfaces that are connected to the portable terminal are WLAN, CDMA, DMB, and Bluetooth.

In FIG. 2, a “process 1” is a process that is related to data transmission. The process 1 is set such that it is allowed to open only external interfaces for “WLAN” and “Bluetooth” among a plurality of external interfaces. Further, a “process 2” is a process that is related to a conversion by telephone. The process 2 is set such that it is allowed to open only “CDMA” among the plurality of external interfaces. A “process 3” is a process that is related to broadcasting reception. The process 3 is set such that it is allowed to open only external interfaces for “WLAN” and “DMB” among the plurality of external interfaces.

If a system call command that requests to open “WLAN” is input from the “process 3”, the external interface control module 20 calls an external interface policy that corresponds to the “process 3” and confirms whether it is allowed to open “WLAN”. Since the “process 3” is set such that it is allowed to open “WLAN”, the external interface control module 20 inputs a control command, which instructs to open an external interface driver for “WLAN”, to the device driver 10. Accordingly, the device driver 10 allows the “process 3” to open the external interface driver for “WLAN”.

Meanwhile, if a system call command that requests to open “Bluetooth” is input from the “process 3”, the external interface control module 20 calls an external interface policy that corresponds to the “process 3” and confirms whether it is allowed to open “Bluetooth”. Since the “process 3” is set such that it is not allowed to open “Bluetooth”, the external interface control module 20 inputs a control command, which instructs to intercept the external interface driver for “Bluetooth”, to the device driver 10. Accordingly, the device driver 10 allows the “process 3” to intercept the external interface driver for “Bluetooth”.

At this time, the external interface policy may be set such that it is allowed to open at least one external interface with respect to one user process, which may be changed according to a request from the user.

Meanwhile, if a system call command that requests to open an external interface set to be intercepted is input from the user process, a message, which informs that it is requested to open the external interface to be intercepted, may be output, such that the user confirms the message. In this case, the external interface control module 20 inquires the user about whether or not to intercept the corresponding external interface. According to a control command input from the user, the external interface control module 20 inputs a control command, which instructs to temporarily open the external interface that is set to be intercepted, to the device driver 10.

The operation of the present invention that has the above-described structure will now be described.

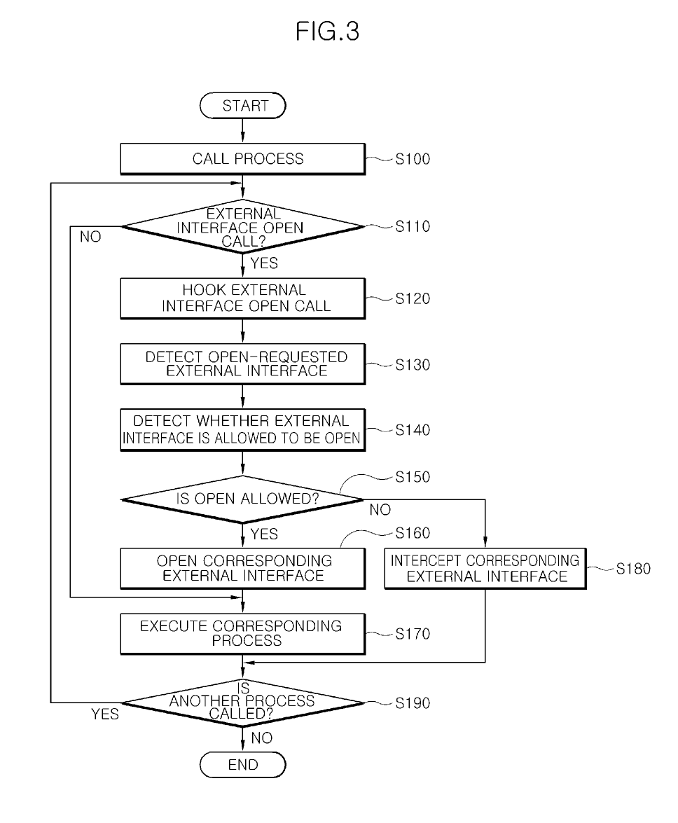

FIG. 3 is a flowchart illustrating an operational flow of a method of controlling an external interface of a portable terminal according to an embodiment of the present invention.

Referring to FIG. 3, if a process call command that is selected in accordance with a request from the user is input (S100), a requested process is executed. At this time, the corresponding process makes an attempt on a system call that requests to open an external interface to allow the corresponding process to be implemented by the device driver 10 (S110). In this case, the device hook 15 hooks a system call command that requests to open the external interface and transmits the system call command to the external interface control module 20 (S120).

The external interface control module 20 detects corresponding process information and information of an open-requested external interface (S130). At this time, the external interface control module 20 calls an external interface policy that corresponds to the detected process, confirms whether or not to allow the open-requested external interface to be open, and provides the confirmed result to the device driver 10 (S140).

When it is confirmed by the external interface control module 20 that the open-requested external interface from the corresponding process is allowed to be open (S150), the device driver 10 opens a driver of the corresponding external interface (S160), thereby allowing the process to be connected to the corresponding external interface and executed (S170).

Meanwhile, when it is confirmed by the external interface control module 20 that the open-requested external interface from the corresponding process is not allowed to be open (S150), the device driver 10 intercepts the driver of the corresponding external interface (S180), thereby causing the process not to be connected to the corresponding external interface. At this time, the device driver 10 outputs a message informing that the external interface is not allowed to the user.

If the user calls another process while the process is executed or after the execution of the process is completed (S190), the processes of Steps S110 and S180 are repeated.

The portable terminal and the method of controlling an external interface thereof according to the present invention are not limited to the structures and methods of the above-described embodiments. A portion or all of the embodiments may be selectively combined and configured such that various changes and modifications can be made in the embodiments.

Meanwhile, the present invention can be implemented as codes, which can be read by a processor such as a mobile station modem (MSM) included in a mobile terminal and stored in a recording medium readable by the processor. Examples of the recording medium that can be read by the processor include all kinds of recording devices where data readable by the processor is stored. Specifically, examples of the recording medium that can be read by the processor may include a ROM, a RAM, a CD-ROM, a magnetic tape, a floppy disk, and an optical data storage device. The recording medium may be implemented in a form of a carrier wave, such as transmission through the Internet. In the recording medium that can be read by the processor, codes can be stored and executed, which are distributed to a computer system connected through a network and can be read by the processor in a distribution method.

The present invention is not limited to the above-described embodiment, and it will be apparent to those skilled in the art that various changes and modifications can be made without departing from the spirit and scope of the present invention, and the changes and the modifications are included in the following appended claims.

What is claimed is:

1. A portable terminal that is connected to a plurality of external interfaces, comprising:
an external interface control module that confirms whether or not to open an open-requested external interface on the basis of an external interface policy where open or intercepted information for each of the plurality of external interfaces is recorded to correspond to a user process, when a system call command that requests to open the external interface is input from the user process; and
a device driver that opens or intercepts the open-requested external interface in accordance with a control command from the external interface control module.

2. The portable terminal of claim 1,
wherein the external interface control module sets the external interface policy for each of a plurality of user processes.

3. The portable terminal of claim 1,
wherein the external interface control module changes the external interface policy in accordance with a request from a user.

4. The portable terminal of claim 1,
wherein the external interface control module detects information of the open-requested external interface by the system call command, and compares the information of the external interface with the external interface policy corresponding to the user process.

5. The portable terminal of claim 1,
wherein the device driver opens or intercepts a driver of the open-requested external interface in accordance with the control command from the external interface control module.

6. The portable terminal of claim 1, further comprising:
a device hook that is implemented in the device driver and transmits the system call command, which is input from the user process and requests to open the external interface, to the external interface control module.

7. The portable terminal of claim 1,
wherein the plurality of external interfaces includes at least one of wireless-LAN (WLAN), code division multiple access (CDMA), digital multimedia broadcasting (DMB), and Bluetooth.

8. A method of controlling an external interface of a portable terminal that is connected to a plurality of external interfaces, comprising:
receiving a system call command that requests to open an external interface from a user process;
confirming whether or not to open the open-requested external interface on the basis of an external interface policy where open or intercepted information for each of the plurality of external interfaces is recorded to correspond to the user process; and
opening or intercepting the open-requested external interface according to the confirmed result.

9. The method of claim 8, further comprising:
setting the external interface policy for each of the plurality of external interfaces, for each of a plurality of user processors.

10. The method of claim 8,
wherein the external interface policy is changed in accordance with a request from a user.

11. The method of claim 8,
wherein the opening or intercepting of the open-requested external interface is opening or intercepting a driver of the open-requested external interface.

12. The method of claim 8, further comprising:
detecting information of the open-requested external interface by the system call command, when the system call command is input.

13. The method of claim 8,
wherein the plurality of external interfaces includes at least one of wireless-LAN (WLAN), code division multiple access (CDMA), digital multimedia broadcasting (DMB), and Bluetooth.
